(19) United States
(12) Patent Application Publication
(10) Pub. No.: US 2013/0161315 A1
(43) Pub. Date: Jun. 27, 2013

(54) Infrared Cooker

(71) Applicant: Edwin Cowan, Newport Beach, CA (US)

(72) Inventor: Edwin Cowan, Newport Beach, CA (US)

(21) Appl. No.: 13/721,757

(22) Filed: Dec. 20, 2012

Related U.S. Application Data
(60) Provisional application No. 61/630,940, filed on Dec. 23, 2011.

(51) Int. Cl. F24C 7/04; A21B 1/22; A21B 1/48; F24C 3/06

(52) U.S. Cl. CPC F24C 7/043; F24C 3/065; A21B 1/22; A21B 1/48
USPC 219/411; 126/39 F; 99/419; 99/443 C

(57) ABSTRACT

An infrared cooker includes an infrared burner element that radiates heat towards a removable cooking surface, the removable cooking surface placed receives heat radiated from the infrared burner element, the cooking surface stores the heat received from the infrared burner element and upon a food item being placed above or upon the removable cooking surface, the food item simultaneously cooks by heat conducted from the removable cooking surface and direct radiation of the infrared burner.

### CROSS-REFERENCE TO RELATED APPLICATION

This application claims the benefit of U.S. provisional patent application No. 61/630,940, filed Dec. 23, 2011.

### BACKGROUND

1. Technical Field

Embodiments of the present invention relate generally to an infrared cooker and, more particularly, to that of a novel infrared cooker for cooking food by an infrared heat source that directs radiation towards and heats a cooking surface. Upon a food item being placed on the cooking surface, the food item is cooked one side by directed radiation of the infrared heat source and on an opposite side by conduction of heat stored by the cooking surface.

2. Description of Related Art

Traditional infrared cookers commonly referred to as “cheese melter”, “salamander” or infrared barbeque are configured to heat a single side of a food item. Such traditional cookers provided a metal box with an infrared burner placed above an open grate. The open grate would hold a plate or a food item while the heat of the infrared burner cooked the top surface of the food item.

Traditional infrared cookers are favored in the preparation of Mexican food where it was necessary to melt cheese quickly on top of an already prepared food item. For example, in the preparation of a Casadia, previously cooked ingredients are rolled within a soft tortilla and then cheese is quickly melted over the top of the rolled soft tortilla.

Traditional infrared cookers are also used in barbequing of meat and other foodstuffs where heat is directed from above toward the top surface of the meat. The high heat of the infrared cookers quickly sears the top surface of the meat locking in fluids. Once cooked on a first side the meat is required to be turned to allow the opposite side of the meat to also be cooked.

### BRIEF SUMMARY

Unfortunately, there are deficiencies with the above-described conventional cooking using infrared burners. In particular, food items cooked by means of an infrared burner are only cooked on a single side. The food item is first cooked on one side by radiating heat from the infrared burner towards the first side of the food item. The food item is then flipped and heat is radiated towards the second side of the food item to allow both sides of the food item to be evenly cooked.

Further, the gas source for a propane infrared barbeque grill is the standard twenty-gallon propane tank. Such tanks are bulky, measuring eighteen inches in height and twelve-inches diameter. In some jurisdictions the use of propane bottles over two and a half gallons in capacity is prohibited for fire safety reasons.

In contrast to the above-described infrared cookers, an improved infrared cooker cooks both sides of a food item simultaneously. Prior to cooking a food item in the infrared cooker, heat is radiated by the infrared burner towards a cooking surface. The cooking surface is heated to a high temperature. Upon the cooking surface attaining a temperature capable of cooking the food item, the food item is placed upon the cooking surface where the food item is cooked on a top surface by the heat radiating from the infrared burner and on the bottom surface by heat conducted from the cooking surface.

Advantageously, the improved infrared cooker provides a means of cooking a food item at higher temperatures and more quickly than infrared cookers of the prior art while providing greater safety by using a small propane bottle.

Further, the infrared cooker combines the radiation from a highly heated infrared burner with the heat received by a metal grill. It is much more sophisticated than simply a combination of elements.

A number of factors must be considered to achieve satisfactory results. Infrared burners are constructed of a highly perforated ceramic plaque about ½″ thick. The face of the plaque can reach temperatures up to 1700 degrees Fahrenheit and it becomes glowing red hot. The burner can flashback if higher temperatures occur. This would be due to the burning gas-air mixture entering back into the burner ports when excessive temperatures are reached on the burning surface.

Infrared radiation occurs with the long wave lengths in the electromagnetic spectrum. The intensity of the radiation is proportional to the fourth power of the surface absolute temperature. In the Fahrenheit scale absolute zero is minus 459.6 degrees Fahrenheit. The warmth discharged is inversely proportional to the square of the distance from the heat source to the heat receiver. With all of these consideration one must proportion the shape and size of the infrared source and the distance from the burner to heat receiving cooking grill. Infrared heat rays are transfer heat at the speed of light or 186000 miles per second.

Cooking a pizza requires a cooking surface from 600 to 700 degrees. Cooking pancakes requires a surface temperature between 400 and 450 degrees Fahrenheit. To achieve these temperatures the cooker must have the right amount of radiant surface and surface temperature. The distance between the burner and the grill must be set to produce grill surface temperature as low as 300 degrees and as high as 700 degrees. This distance we found by test to be between 6 and 8 inches. If these factors are not scientifically adjusted, the end results will not be satisfactory for cooking a variety of foods.

The temperature inside the cooker is also affected by heat losses. Using an insulated front door can increase cooker temperatures inside by 150 degrees. Insulating the walls of the cooker increase the inside temperature by as much as 100 degrees. This increased efficiency allows us to use less gas. The energy used at the LOW input setting is only 3,000 Btu/hr. Similar low input gas appliances use up to 18,000 Btu/hr. A small one pound Propane tank can cook for 7 hours. With an average cooking time of 15 minutes, 28 meals can be cooked before a newly filled Propane gas tank is needed. The small Propane tank is a safety consideration and minimized the chance of explosion occurring. The cooker uses no electricity and is completely portable for use anywhere. Its weight is only 15 pounds and is easy to carry or be moved on a small plastic luggage cart.

An aspect of the present invention provides an infrared cooking device, the infrared cooker includes an infrared burner element that radiates heat towards a plane opposite from the infrared burner element and a removable cooking surface, the removable cooking surface placed parallel with the plane receives the heat radiated from the infrared burner element, the cooking surface stores the heat received from the infrared burner element, upon a food item being placed above or upon the removable cooking surface, the food item simultaneously cooks by heat conducted from the removable cooking surface and direct radiation of the infrared burner.

This Summary is provided to introduce a selection of concepts in a simplified form that are further described below in the Detailed Description. This Summary is neither intended to identify key features or essential features of the claimed subject matter, nor should it be used to limit the scope of the claimed subject matter. Furthermore, the claimed subject matter is not limited to implementations that solve any disadvantage noted in any part of this application.

The aforementioned and/or other features, aspects, details, utilities, and advantages of the present invention are: set forth in the detailed description which follows and/or illustrated in the accompanying drawings; possibly inferable from the detailed description and/or illustrated in the accompanying drawings; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1. is an external front view of an infrared cooker according to an embodiment of the present invention;

FIG. 2. is an external top view of an infrared cooker according to an embodiment of the present invention;

FIG. 3. is an external cutaway front view of an infrared cooker according to an embodiment of the present invention;

FIG. 4. is an internal cutaway upwards view of an infrared cooker according to an embodiment of the present invention;

FIG. 5. is an external cutaway front view of an infrared cooker with rotisserie according to an embodiment of the present invention;

FIG. 6. is an external cutaway side view of an infrared cooker with drip pan positioned to radiate heat outwards according to an embodiment of the present invention;

FIG. 7. is an external cutaway front view of an infrared cooker with cooking surface according to an embodiment of the present invention;

FIG. 8 is a cooking surface with a flat surface;

FIG. 9 is a reversed side cooking surface with a with raised grooved; and

FIG. 10 is an external cutaway side view of an infrared cooker with a conveyer system according to an embodiment of the present invention.

FIG. 11 is an upward view of a burner installation with multiple infrared burners.

FIG. 12 is a front view of the infrared burner installation with multiple infrared burners.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

Although the following text sets forth a detailed description of at least one embodiment or implementation, it is to be understood that the legal scope of protection of this application is defined by the words of the claims set forth at the end of this disclosure. The detailed description is to be construed as exemplary only and does not describe every possible embodiment since describing every possible embodiment would be impractical, if not impossible. Numerous alternative embodiments and/or implementations are both contemplated and possible, using either current technology or technology developed after the filing date of this patent, which would still fall within the scope of the claims

It is to be understood that, unless a term is expressly defined in this application using the sentence “As used herein, the term ‘ ’ is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

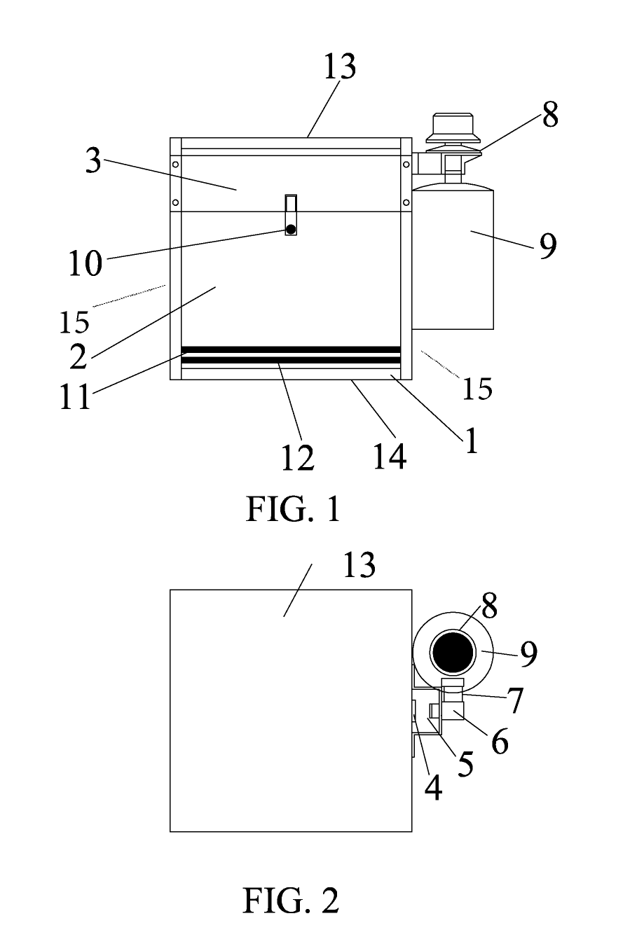

FIG. 1 illustrates an infrared cooker 1 from a front view. The infrared cooker 1 is a cube shaped cabinet having a top 13, a bottom 14, side wall 15 and a front wall including a flue cover 3, door and latch 10 for fastening the door in the closed position and a back wall not (not shown). Mounted on one side wall 15 is an external gas source 9 for providing gas to the infrared cooker 1 and a valve-regulator 8 for controlling the flow of gas into the infrared cooker 1. It will be understood that the gas source 9 is a propane bottle containing liquefied gas. For example, and without limiting the gas source, a one pound propane cylinder. It will be understood that other size cylinders, other gas types and other energy types may be used to supply energy to the infrared cooker 1.

While an external gas source 9 and infrared burner 4 powered by gas are shown, alternatively the infrared burner 4 could be powered by an external electric source.

It will be understood that the cabinet of the infrared cooker 1 can be other than cube shaped. Further, the cabinet has an outer shell and an inner shell. The inner shell providing insulation and removable to allow the inner surfaces of the infrared cooker to be washed.

FIG. 2. is an illustration of an infrared cooker 1 from a top view. From the top view the gas source 9 and valve-regulator 8 are seen in relief. The valve-regulator 8 is attached to a close nipple 7, which in turn is connected an elbow 6 and gas flow orifice 5 and burner inlet air venturi 4.

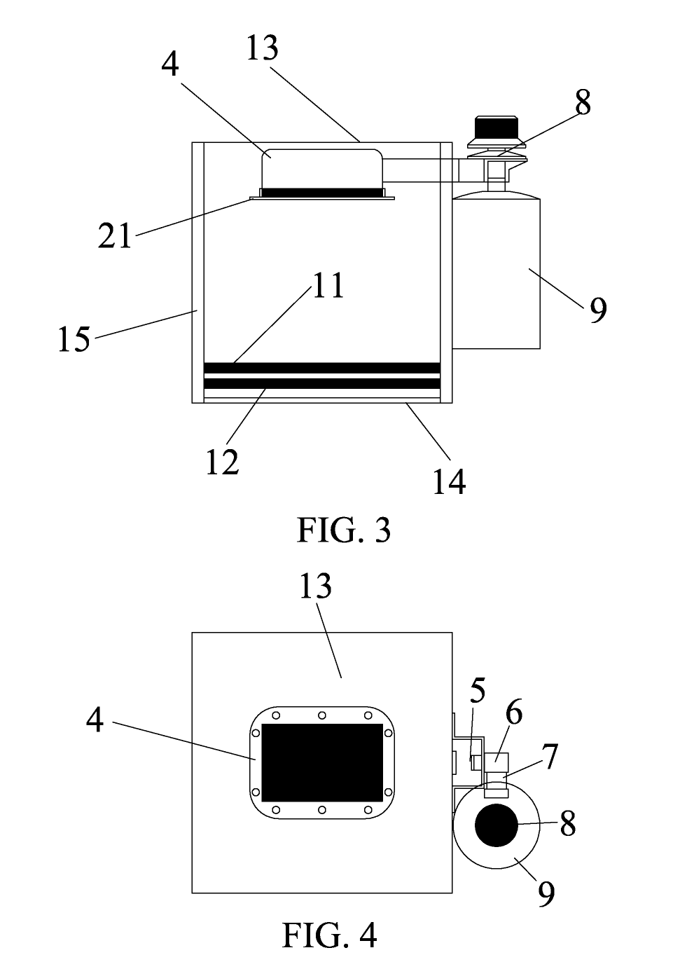

FIG. 3. is a cutaway illustration of an infrared cooker 1 from a front view. The infrared cooker 1 includes an infrared burner 4 having an outside surface 21. It will be understood that the infrared burner 4 is connected to gas flow orifice 5 to provide gas to the infrared burner 4 in a first plane. Heat from the infrared burner 4 radiates towards a cooking surface 11 parallel with a second plane. The cooking surface 11 absorbs the heat radiated from the infrared burner thereby raising the temperature of the cooking surface 11. For example, and infrared burner 4 glowing at 1600 degrees Fahrenheit could heat the cooking surface 11 to 600 degrees Fahrenheit. It would be understood that varying the temperature of the infrared burner 4 radiating heat towards the cooking surface 11 alters the temperature of the cooking surface 11.

In a normal operation the infrared burner 4 will achieve a temperature of 1500-1700 degrees Fahrenheit. Correspondingly the cooking surface 11 will a temperature of 300-600 degrees Fahrenheit.

The cooking surface 11 is inserted and removed via the door 2 when the door 2 is in an open position. The cooking surface 11 sits on top of a drip pan 12 for catching grease and oils released from a food item being cooked in the infrared cooker 1. The cooking surface 11 may be adjusted to move towards the infrared burner 12 as required by the needs of the food item to be cooked.

FIG. 4. is a cutaway illustration of an infrared cooker 1 viewed in the upward direction towards the top 13. Heat is radiated from the glowing surface of the infrared burner 4. In a normal configuration, the infrared burner 4 will be an infrared ceramic burner plaque with micro holes for the mixture of gas and oxygen allowing the infrared burner 4 to burn and radiate at a high temperature to heat the cooking surface 11.

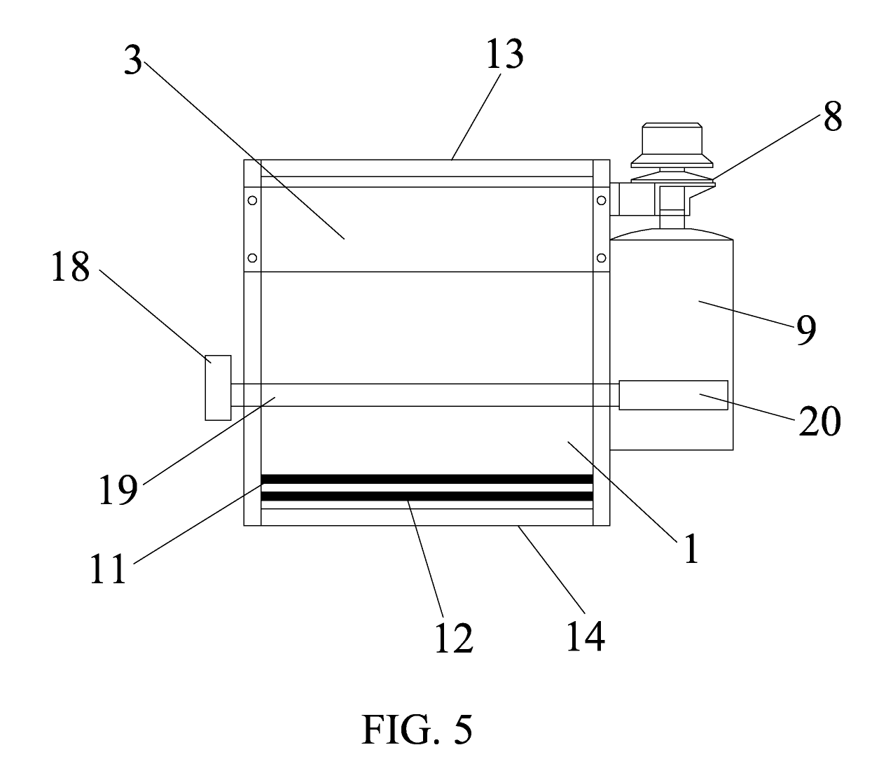

FIG. 5. is a cutaway illustration of the infrared cooker 1 from the front view. The infrared cooker 1 includes a removable rotisserie that has a rotisserie motor 18 for automatically rotating the rotisserie spit 19 and a rotisserie handle 20 for manually rotating or adjusting the rotisserie spit 19.

Prior to cooking, for example, a small chicken (not shown), in the infrared cooker 1, the infrared burner 4 is lit by opening the valve-regulator 8 to allow gas to flow to the infrared burner 4 where an operator of the infrared cooker 1 provides a flame or spark via conventional means to allow combustion of the gas. The valve-regulator 8 is adjusted to provide the correct output temperature. The infrared burner 4 provides heat at a high temperature and radiates the heat towards the cooking surface 11. The cooking surface 11 retains a portion of the heat radiated from the infrared burner 4.

The chicken is placed on the rotisserie spit 19 fed from one side wall 15 of the infrared cooker 1 to the other side wall 15. The rotisserie motor 18 and/or the rotisserie handle 20 then rotate the rotisserie spit 19. The chicken or other food item (not shown) on the spit is cooked by heat radiating from the infrared burner 4 and heat radiating back from the cooking surface 11 to wards the chicken or other food item. In this manner, the chicken or other food item on the rotisserie spit 19 is cooked from both sides.

The chicken or other food item on the rotisserie spit 19 does not entirely block the cooking surface 11, thus it will be understood that the cooking surface 11 continues to absorb heat radiated from the infrared burner 4 during the cooking process.

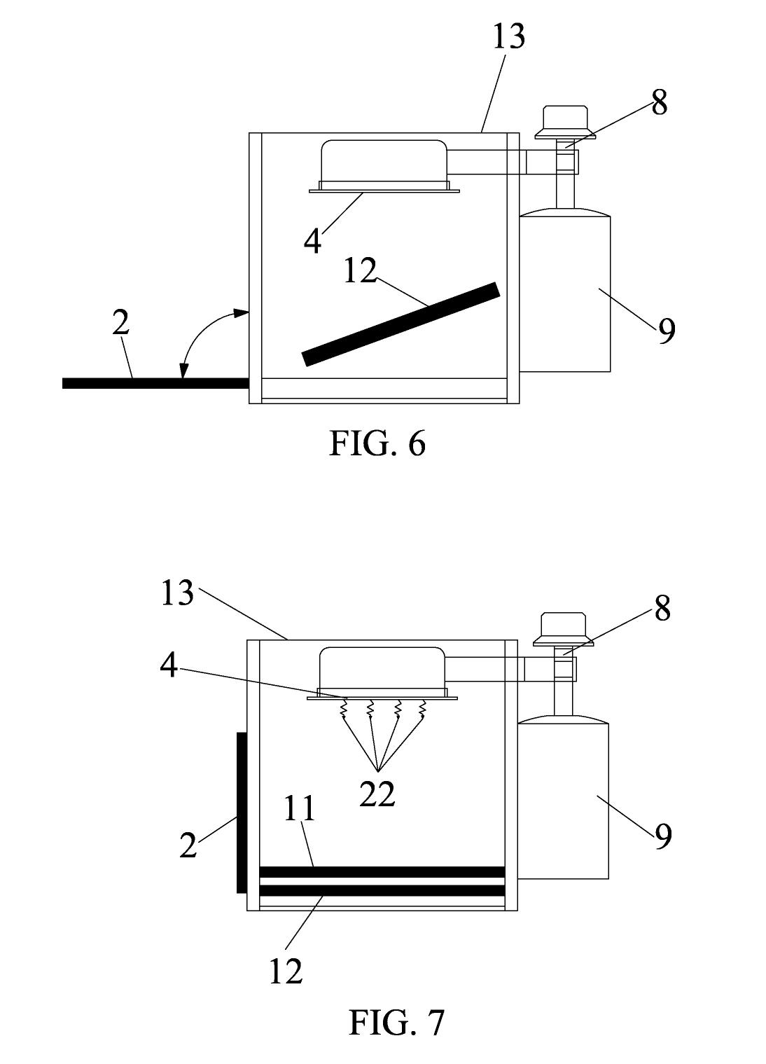

FIG. 6. illustrates an external cutaway side view of the infrared cooker 1 from a side view with drip pan 12 positioned to radiate heat out of the infrared cooker 1. The infrared cooker 1 includes a door 2 in an open position. The drip pan 12 is inverted and positioned at an angle where one end of the drip pan 12 is positioned high on the back wall of the infrared cooker 1. The drip pan 12 reflects the heat radiated from the infrared burner 4 outward away from the infrared cooker 1. It would be understood by one of ordinary skill in the art that drip pan 12 retains its angled position within the infrared cooker by fasteners well known in the art.

By reflecting the heat from infrared burner 11 off the drip pan 12, the infrared cooker 1 heats areas outside the infrared cooker 1.

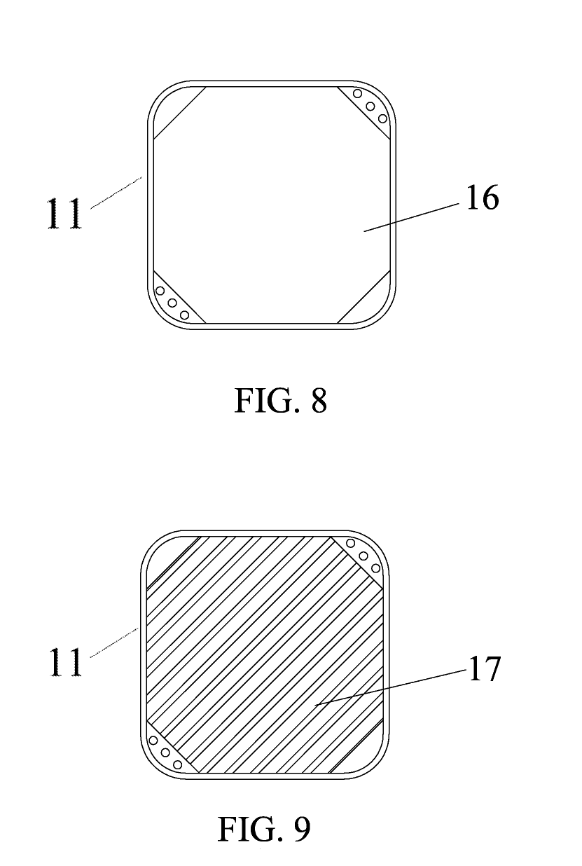

FIG. 7. Illustrates a cutaway front view of an infrared cooker 1 with cooking surface 11 for cooking food simultaneously on a top surface and a bottom surface of the food item. The infrared burner 4 radiates heat 22 in the direction of the cooking surface 11. The cooking surface 11 is thereby heated to a temperature adequate to cook the food item.

Upon the cooking surface 11 reaching the correct temperature for cooking the food item, the cooking surface 11 is removed from the infrared cooker 1 through the door 2. It will be understood that the cooking surface 11 is removed and inserted into the infrared cooker using a removable handle (not shown). The food item is placed upon the cooking surface 11 and the cooking surface 11 is inserted into the infrared cooker 1. Alternatively, the food item is placed within the infrared cooker 1 using an appliance such as tongs, fork, spatula or the like (not shown).

The food item touching the cooking surface conducts the heat stored in the cooking surface 11 and begins cooking on the bottom surface of the foot item. Simultaneously, the infrared burner continues to radiate heat towards the cooking surface. The heat radiating from the infrared burner 4 heats and thereby cooks the upper surface of the food item. Additionally, the heat radiating 22 from the infrared burner 4 continues to heat the cooking surface 11, such heat transferred by conduction to the portion of the cooking surface 11 below the food item.

By simultaneously heating the food item from above via heat radiated by the infrared burner 4 and from below via conduction of the heat stored in the in cooking surface 11, the food item cooks more rapidly than in prior art infrared cookers that only actively cook a single side of a food item at any given time.

FIGS. 8 and 9 illustrate cooking surface 11 in multiple forms used to cook varying food items. FIG. 8 illustrates a cooking surface with a flat surface 16 used for cooking food items, such as bacon and eggs, pizza, vegetables and other food items requiring a flat surface for cooking.

FIG. 9 illustrates a cooking surface 11 with a ribbed surface 17 for cooking food items such as meats where presentation of the food items requires grill marks and allows for draining of fats and fluids away from the food items.

The cooking surface 11 as shown in FIGS. 8 and 9 is removable from infrared cooker 1 by means of a detachable handle (not shown). The cooking surface 11 as shown conforms to the inner dimensions of the infrared cooker. However, other shapes and sizes may be used as the cooking surface 11 provided the alternative cooking surface fits into the infrared cooker 1.

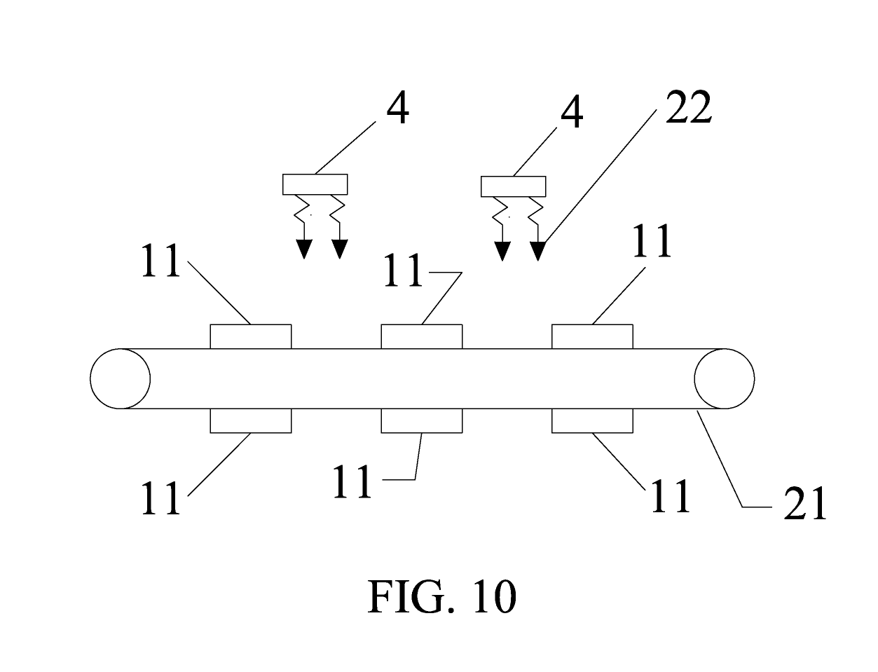

FIG. 10 illustrates an external cutaway side view of an infrared cooker with a conveyer system. In an alternative configuration cooking of a food item, such as pizza, is performed in assembly line manner. The infrared cooker 1 contains at least a single infrared burner 4. However, more than one infrared burner 4 may be configured in a series above a conveyer system 21. The conveyer 21 conveys the food item, such as pizza, on top of a series of cooking surface 11. The food item is cooked simultaneously cooked by convection from the cooking surface 11 and the directed heat radiated from the infrared burner 4.

As the food item, such as pizza cooks more rapidly than in conventional pizza ovens, the length of the conveyer system is shorter than in conventional pizza ovens.

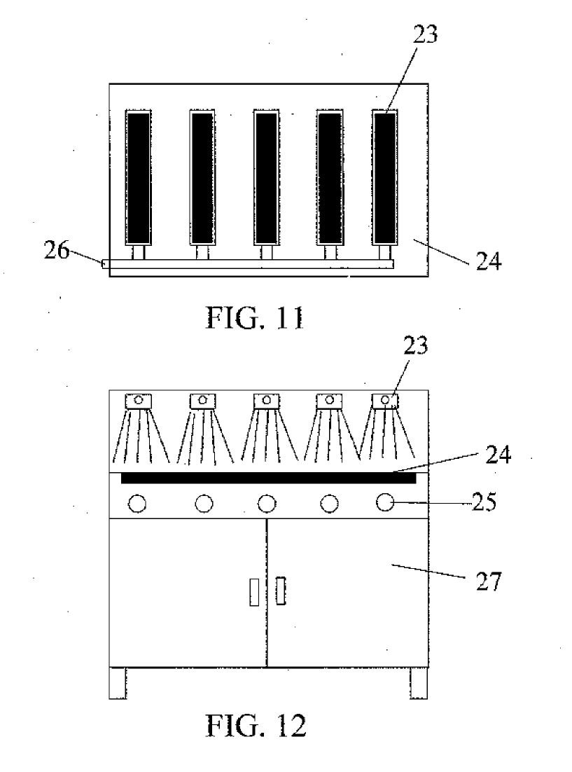

FIG. 11 illustrates a multiple infrared burner installation from view looking upward. The multiple infrared burner installation has a plurality of infrared burners 23 placed at intervals of several inches above the cooking surface 24. Each of the infrared burners 23 provides heat applied to cooking surface 24. Each of the infrared burners 23 receives a gas and air mixture via the connection 26. In the manner discussed above, the infrared burners 23 each radiate heat towards the cooking surface 24. The cooking surface 24 increases in temperature over time as the heat radiated by the infrared burners 23 are absorbed and stored by cooking surface 24. The cooking surface 24 may also receive and store energy from burners below the grill.

A food item (not shown) placed upon the cooking surface 24 cooks on a first side (bottom side) by conducting heat from the cooking surface 24. It will be understood that the infrared burners 23 continue to direct heat towards both the food item thereby cooking the second surface (top side) and continuing to heat the surface area of the cooking surface 24 not covered by the food item.

FIG. 12 illustrates a front view of the infrared burner grill system. Control valves 25 are used to control the heat input from the burners (not shown) beneath the cooking surface 24 as well as control the infrared burners 23 above the grill. The supporting cabinet 27 may be employed to support the weight of the grill and control system. The effect of adding infrared burners 23 to the top side of the grill is to cook the food item at greater rate than those achieved by a conventional grill. By heating the food item from both sides at the same time, the food item becomes sealed on both surfaces imparting a more flavorful taste to the food by retaining the liquids in the food item.

Examples of various features/aspects/components/operations have been provided to facilitate understanding of the disclosed embodiments of the present invention. In addition, various preferences have been discussed to facilitate understanding of the disclosed embodiments of the present invention. It is to be understood that all examples and preferences disclosed herein are intended to be non-limiting.

Although selected embodiments of the present invention have been shown and described individually, it is to be understood that at least aspects of the described embodiments may be combined.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

I claim:

1. An infrared cooking device, comprising:
an infrared burner element, the infrared burner element radiates heat towards a plane opposite from the infrared burner element; and
a removable cooking surface, the removable cooking surface placed parallel with the plane receives the heat radiated from the infrared burner element, the cooking surface stores the heat received from the infrared burner element, upon a food item being placed above or upon the removable cooking surface, the food item simultaneously cooks by heat conducted from the removable cooking surface and direct radiation of the infrared burner.

2. The infrared cooking device according to claim 1, wherein the infrared burning element has a temperature of 1500° to 1700° Fahrenheit.

3. The infrared cooking device according to claim 2, the cooking surface has a temperature of 300° to 700° Fahrenheit.

4. The infrared cooking device according to claim 1, further comprising:
an outer shell, the outer shell including a top, a bottom, a front, a back and two sides.

5. The infrared cooking device according to claim 4, wherein the front of the outer shell includes:
a door, the door connect to the front of the outer shell by a hinge, the hinge arranged and configured to allow at least a region of the front having an opened position and a closed position, the door in the closed position prevents heat from escaping the infrared cooker.

6. The infrared cooking device according to claim 5, wherein the removable cooking surface is inserted and removed via the at least the door of the outer shell in the opened position.

7. The infrared cooking device according to claim 6, further comprising:
a reflecting surface, wherein the reflecting surface is titled to radiate heat towards the at least the region of the front of the outer shell when the door is in the opened position.

8. The infrared cooking device according to claim 1, wherein the cooking surface is a rectangular skillet with four (4) sides.

9. The infrared cooking device according to claim 1, wherein the removable cooking surface is round.

10. The infrared cooking device according to claim 1, wherein the infrared burner element receives energy from a gas or electric source.

11. The infrared cooking device according to claim 10, wherein the energy is an external gas supply is a bottle of compressed gas externally mounted on the infrared cooking device.

12. The infrared cooking device according to claim 10, wherein the gas received by the infrared burner element is controlled via an orifice in a plug, a pressure regulator and a valve.

13. The infrared cooking device according to claim 1, further comprising:
a conveyer belt, the conveyer belt conveying the cooking surface past the infrared burner element.

14. The infrared cooking device according to claim 13, wherein the infrared burner element is a series of infrared burner elements, and
the cooking surface is a series of grills.

15. The infrared cooking device according to claim 4, further comprising:
an insulated inner shell, the insulated inner shell insulated to prevent heat loss.

16. The infrared cooking device according to claim 1, further comprising:
a rotisserie inserted between the infrared burner and the cooking surface, the rotisserie rotating the food item.

17. The infrared cooking device according to claim 1, wherein the infrared burner element is at lest two infrared burner elements in a series.

18. An infrared cooker for simultaneously cooking a bottom and top surface of a food item, comprising:
an enclosure;
an infrared burner, the infrared provides a primary heat source for the cooking of food; and
a cooking surface, the cooking surface inserted into the enclosure, the heat of the infrared burner absorbed by the cooking surface and used as a secondary heat source for the cooking of food,
wherein a food item placed within the enclosure receives heat on a top surface of the food item from the infrared burner while simultaneously a bottom surface of the food item conducts heat from the cooking surface.
